(19) United States
(12) Patent Application Publication
(10) Pub. No.: US 2007/0075963 A1
(43) Pub. Date: Apr. 5, 2007

(54) Bi-stable display with dc-balanced over-reset driving

(76) Inventors: Guofu Zhou, Best (NL); Mark T. Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/579,408

(22) PCT Filed: Nov. 12, 2004
(86) PCT No.: PCT/IB04/52409

§ 371 Date: May 15, 2006

Related U.S. Application Data
(60) Provisional application No. 60/520,622, filed on Nov. 17, 2003.
(60) Provisional application No. 60/586,948, filed on Jul. 9, 2004.

(51) Int. Cl. G09G 3/34

(52) U.S. Cl. 345/107

(57) ABSTRACT

A display device (101) has groups of display elements (118), which are changed from one optical state to another optical state by applying a waveform sequence of potential differences. The waveform enables particles (108, 109) to occupy a position corresponding to the other optical state and includes standard reset, over-reset and grayscale drive. The standard reset part of the waveform applies a potential difference, which is proportional to a distance the particles (108, 109) must move to reach one of the extreme optical states and the over-reset is independent of the distance. Grayscale or color scale accuracy is improved and direct charge on a pixel may be balanced over time with consequent grayscale drift compensated by tuning the grayscale driving pulse.

The invention relates generally to electronic reading devices such as electronic books and electronic newspapers and, more particularly, to a method and apparatus for updating images with improved image quality and reduced update time using both monochrome and grayscale images.

Recent technological advances have provided “user friendly” electronic reading devices such as e-books that open up many opportunities. For these uses, electrophoretic displays hold much promise. Such displays have an intrinsic memory behavior and are able to hold an image for a relatively long time without power consumption. Power is consumed only when the display needs to be refreshed or updated with new information. The power consumption in such displays is very low, suitable for applications for portable e-reading devices like e-books and e-newspaper. Electrophoresis takes place in movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

An electrophoretic display comprises an electrophoretic medium (“electronic ink”) containing charged particles in a fluid, a plurality of display elements (pixels) arranged in a matrix, first and second electrodes associated with each pixel, and a voltage driver for applying a potential difference to the electrodes of each pixel to cause charged particles to occupy a position between the electrodes, depending on the value and duration of the applied potential difference, so as to display an image or other information.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003, —digest 20.3). Colored particles may also be used.

To form an electronic display, the electronic ink may be printed onto a sheet of plastic film that is laminated to a layer of circuitry. The circuitry forms a pattern of display elements (pixels) that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

Further advancements are needed to improve image quality and reduce image update time.

One of the major challenges in the research and development of an electronic ink type electrophoretic display is to achieve accurate gray levels, which are generally created by applying voltage pulses for specified time periods. The accuracy of the greyscales in electrophoretic displays is strongly influenced by image history, dwell time, temperature, humidity, lateral inhomogeneity of the electrophoretic foils etc. The accurate grey levels can be achieved using rail-stabilized approach, which means that the grey levels are reached either from reference black or from reference white state (the two rails).

The present invention provides a solution that overcomes these problems related to achieving accurate gray scale and other problems encountered in prior art bi-stable displays.

In one aspect, the present invention relates to a method for addressing a bi-stable display element using a rail-stabilized driving scheme with DC-balanced over-reset pulse, in, in particular, an electrophoretic display with at least two bits grayscale. The reset impulse has both “standard reset” and “over-reset” components, regardless of the image update sequence. The “standard reset” impulse (involved energy) is proportional to the distance required for the electronic ink to move to a rail.

For example, when pulse width modulation (PWM) driving is used, the full pulse width (FPW) is required for resetting the display from white to black and only ⅔ of the FPW is needed from light gray to black and ⅓ of the FPW from dark gray to black. This standard reset pulse time is naturally zero from black to black. A constant “over-reset” impulse must, however, be chosen independently of the distance that ink needs to move during reset. If, for example, the display is to be reset to black state from white, light gray, dark gray or black, a constant over-reset impulse must be applied, including the reset from black to black. When the above total reset impulse is symmetrically applied to both black and white, the driving is ideally DC-balanced. A rail-stabilized driving scheme with DC-balanced over-reset pulse is thus implemented for an electrophoretic display with at least two bits grayscale.

In another aspect, the present invention relates to a method of addressing a bi-stable display element using an over-reset pulse for DC-balancing of the display 10 element. The DC-balancing is such that the average potential difference applied to the display element over a time period is zero. For example, after an irreversible loop: white to dark gray to white, the net DC on the pixel should be zero. The grayscale driving pulses are adjusted accordingly to take into account the DC-balancing. Not only are the over-reset pulses adjusted for DC balancing, but the DC-balancing applied by the over-reset to a display element is also reflected in the proration of the FPW.

These and other aspects of the invention will be apparent from and elucidated with reference to the embodiment(s) described hereinafter.

In the drawings:

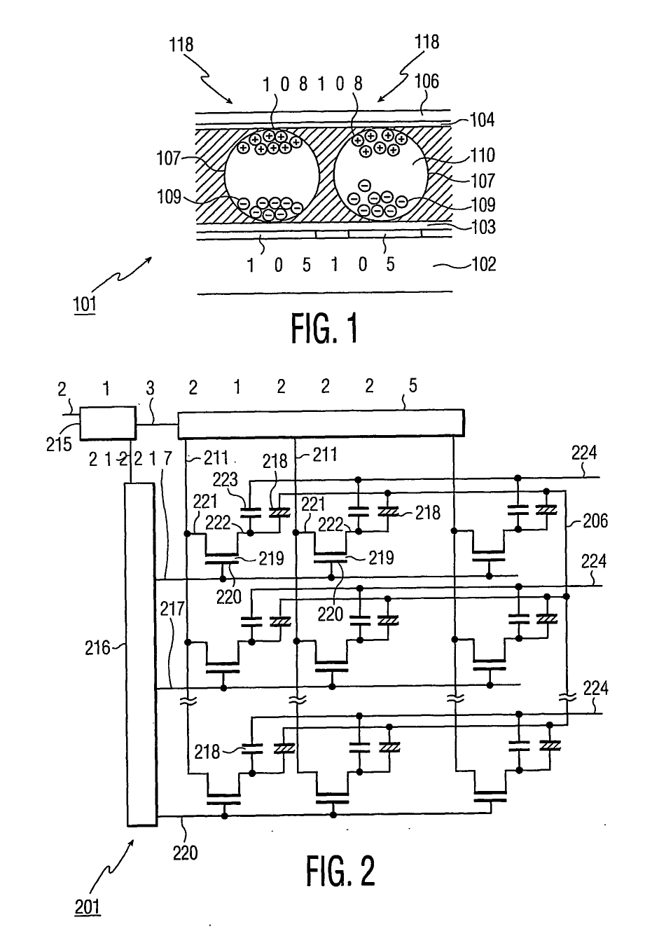

FIG. 1 is a diagrammatic cross-section of a portion of a display device.

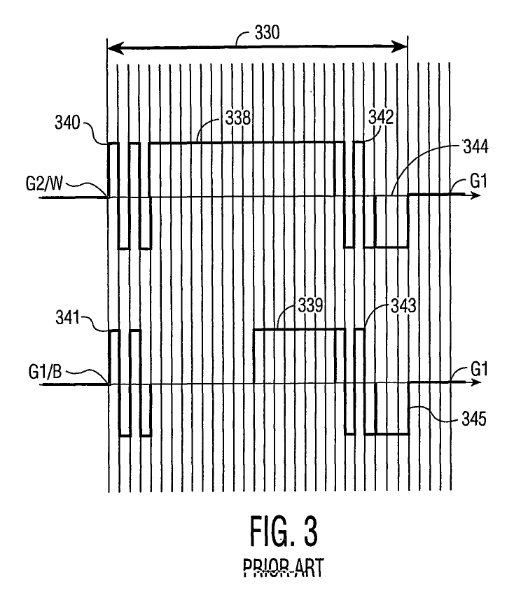

FIG. 2 is an equivalent circuit diagram of a portion of a display device.

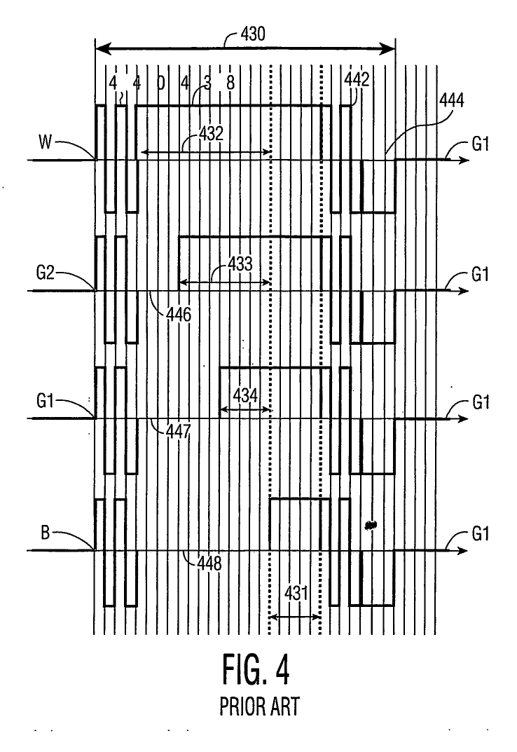

FIG. 3 illustrates a prior art driving method.

FIG. 4 shows a first embodiment of a driving scheme according to this invention using pulse width modulation (PWM) driving.

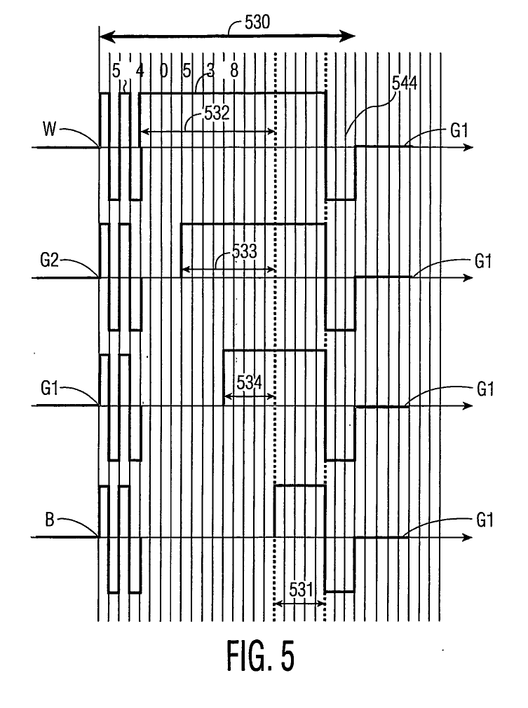

FIG. 5 shows a second embodiment using PWM driving without a second series of shaking pulses.

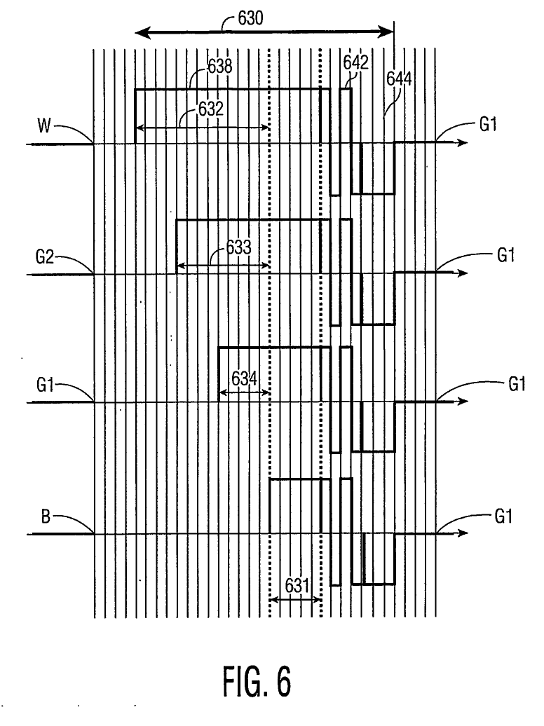

FIG. 6 shows a third embodiment in which PWM driving is used without a first series of shaking pulses.

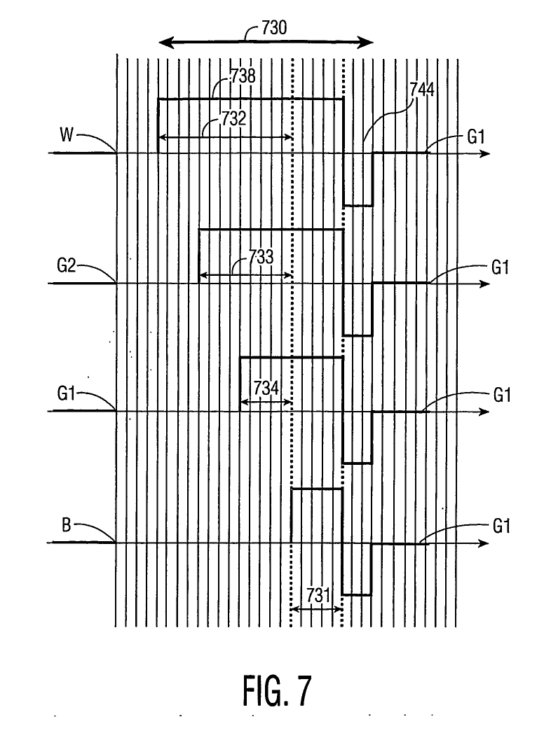

FIG. 7 shows a fourth embodiment using PWM driving without a first or second series of shaking pulses.

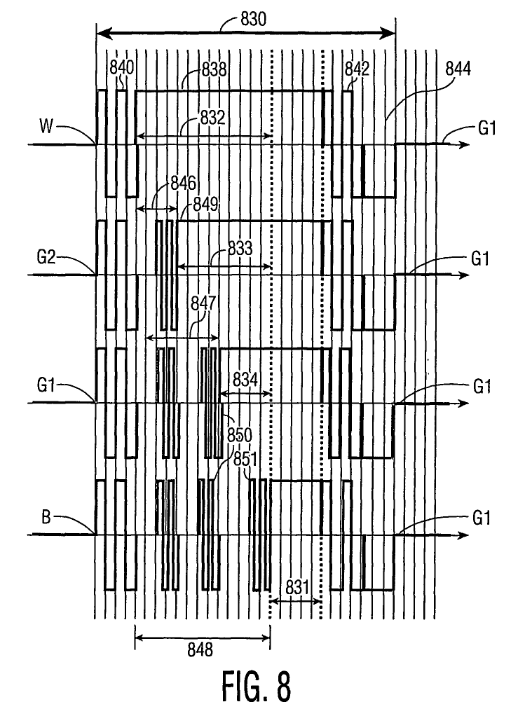

FIG. 8 shows a fifth embodiment using PWM driving with additional shaking pulses in short sequences.

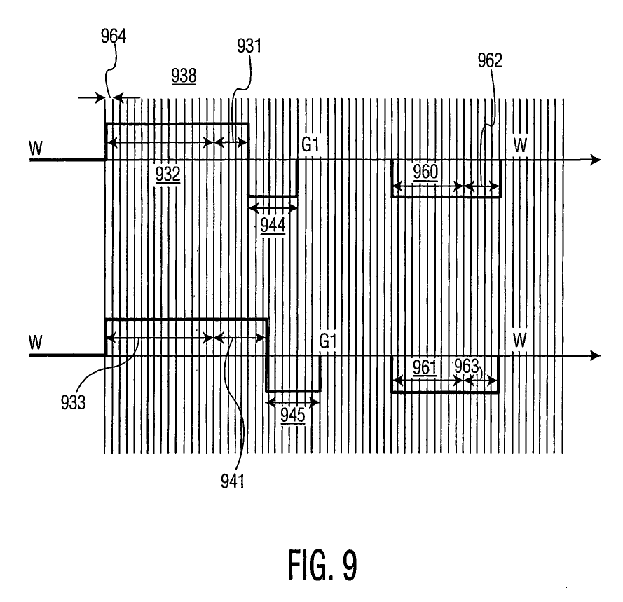

FIG. 9 shows a sixth embodiment using PWM driving to achieve DC-balancing in a white-dark gray-white loop for a practically imperfect ink material (sensitive to dwell time and image history.).

The Figures are schematic and not drawn to scale, and, in general, like reference numerals refer to like parts.

FIG. 1 is a diagrammatic cross-section of a portion of an electrophoretic display device 101, for example of the size of a few display elements 118, each comprising a base substrate 102, an electrophoretic film with an electronic ink which is present between two transparent substrates 103, 104 of, for example, polyethylene. One of the substrates 103 is provided with transparent pixel electrodes 105 and the other substrate 104 is provided with a transparent counter electrode 106. The electronic ink comprises multiple microcapsules 107 of about 10 to 50 microns. Each microcapsule 107 comprises positively charged white particles 108 and negatively charged black particles 109 suspended in a fluid 110. When a negative field is applied to the counter electrode 106, the white particles 108 move to the side of the microcapsule 107 directed to the counter electrode 106, and the display element 118, here comprising the counter electrode 106, pixel electrode 105 and microcapsule 107, becomes visible to a viewer. Simultaneously, the black particles 109 move to the opposite side of the microcapsule 107 where they are hidden from the viewer. By applying a positive field to the counter electrodes 106, the black particles 109 move to the side of the microcapsule 107 directed to the counter electrode 106, and the display element appears dark to a viewer (not shown). When the electric field is removed, the particles 107 remain in the acquired state and the display exhibits a bi-stable character and consumes substantially no power.

FIG. 2 is an equivalent circuit diagram of a picture display device 201 comprising an electrophoretic film laminated on a base substrate 202 provided with active switching elements, a row driver 216 and a column driver 225. Preferably, a counter electrode 206 is provided on the film comprising the encapsulated electrophoretic ink, but could be alternatively provided on a base substrate in the case of operation with in-plane electric fields. The display device 201 is driven by active switching elements, in this example thin-film transistors 219. It comprises a matrix of display elements at the area of crossings of row or selection electrodes 217 and column or data electrodes 211. The row driver 216 consecutively selects the row electrodes 217, while a column driver 225 provides a data signal to the column electrode 211. Preferably, a controller 215 first processes incoming data 213 into the data signals. Mutual synchronizations between the column driver 225 and the row driver 216 takes place via drive lines 212. Select signals from the row driver 216 select the pixel electrodes 222 via the thin-film transistors 219 whose gate electrodes 220 are electrically connected to the row electrodes 217 and the source electrodes 221 are electrically connected to the column electrodes 211. A data signal present at the column electrode 211 is transferred to the pixel electrode 222 of the display element coupled to the drain electrode via the TFT. In the embodiment, the display device of FIG. 1 also comprises an additional capacitor 223 at the location of each display element 218. In this embodiment, the additional capacitor 223 is connected to one or more storage capacitor lines 224. Instead of TFTs, other switching elements can be used, such as diodes, MIMs, etc.

FIG. 3 illustrates a prior art driving method. A driving method of this kind using a single over-reset voltage pulse has been found to be very promising for driving an electrophoretic display. Such a method is described in a prior, co-pending, non-prepublished application EP 03100133.2, filed Jan. 23, 2003 (Applicants' docket no. PHNL030091). The horizontal direction in FIG. 3 is time, with the sub-frame time (SFT) durations marked. The vertical direction is the amplitude of the potential difference applied to a display element. The duration 330 in FIG. 3 is the total image update time. In this example, image updates to dark gray G1 from light gray G2 and white W and black B and dark gray G1 are shown with reset pulses 338, 339 including over-reset. The pulse sequence typically has four portions: first shaking pulses 340, 341, reset pulse 338, 339, second shaking pulses 342, 343 and grayscale driving pulse 344, 345. The sequences shown in FIG. 3 are for image transition to dark gray G1 from black B, dark gray G1, light gray G2 and white W. Four transitions to G1 state from W, G2, G1, B are realized using two types of pulse sequences using over-reset for resetting the display: There is a long sequence for the transitions from G2 or W to G1 and a short sequence for G1 or B to G1. This method is, however, not DC-balanced.

FIG. 4 shows a first embodiment of a driving scheme according to the present invention, here using pulse width modulation (PWM) driving. The horizontal direction in FIG. 4 indicates time, with the SFT durations marked. The amplitude of the potential difference applied to a display element is represented by the vertical dimension. The duration 430 in FIG. 4 is the total image update time. The reset pulses 438 have two parts: the standard reset time 432, 433, 434 and the over-reset time 431 for the same types of image transitions as in FIG. 3, i.e. for the transitions from black B, dark gray G1, light gray G2 and white W to dark gray G1. The over-reset time tₒᵥₑᵣ₋ᵣₑₛₑₜ 431 is constant regardless of the image transitions. The standard reset time 432, 433, 434 is proportional to the distance required for the particles in the electronic ink to move in a direction at a right angle to the substrates of the display (102, 103, 104 in FIG. 1), indicated as times t₁ 432, t₂ 433 and t₃ 434 for transitions from W, G2 and G1 to G1 respectively. Short sequences 446, 447, 448 during which no voltage is applied to the display element are created by setting the standard reset time 432, 433, 434 according to the distance the particles are to move.

This first embodiment schematically shown in FIG. 4 is of a display having at least 2-bits gray levels: black B, dark gray G1, light gray G2 and white W. Four types of pulse sequences are used for the four different transitions to G1 state from W, G2, G1, B and each sequence has four portions: first shaking pulses 440, reset 438, second shaking pulses 442 and driving 444. Usually, t₁ 432 is equal to the saturation time which is the minimum time required for switching the display from full black to full white. t₂ 433 is the subtraction of the saturation time and the time used in the previous grayscale driving pulse from W to G2. t₃ 434 is equal to the time used in the previous grayscale driving pulse from B to G1. In an ideal case, the grayscale driving pulses for W to G2 or B to G1 have a pulse period ⅓ of the saturation time t₁ 432. t₂ 433 becomes then ⅔ of t₁ 432, and t₃ 434 becomes ⅓ of t₁ 432. Meanwhile, tₒᵥₑᵣ₋ᵣₑₛₑₜ 431 is always the same in all image transitions including reset from black to black or white to white. When the same principle is applied for the image transitions via opposite rail, a completely symmetric driving is realized, which is ideally DC-balanced.

FIG. 5 illustrates a second embodiment according to this invention in which PWM driving is also used, but the second shaking pulses 442 of the first embodiment are absent. As in FIG. 3 and FIG. 4, the horizontal direction in FIG. 5 represents time, with the SFT durations marked. The vertical direction represents the amplitude of the potential difference applied to a display element. The duration 530 in FIG. 5 is the total image update time. The reset pulses 538 have two parts: the standard reset time 532, 533, 534 and the over-reset time 531 for the same types of image transitions as in FIG.'s 3 and 4, i.e. for the transitions from black B, dark gray G1, light gray G2 and white W to dark gray G1. The over-reset time tₒᵥₑᵣ₋ᵣₑₛₑₜ 531 is constant regardless of the image transitions. Each sequence of potential differences here has only three portions: first shaking pulses 540, reset 538 and driving 544. Counterparts of the second series of shaking pulses 442 in FIG. 4 are, however, not present in any of the transition sequences, W, G2, G1, B to G1. In this embodiment, the delay of the grayscale introduction is reduced, resulting in more natural image appearance. Also, the total image update time is shortened. The image quality from this embodiment would, however, be diminished in comparison to the first embodiment, because of stronger image retention when less shaking is used.

FIG. 6 illustrates a third embodiment according to this invention using PWM driving, which differs from the first embodiment in that the first series of shaking pulses, 440 in FIG. 4, is not present. As in FIG. 4, the horizontal direction in FIG. 6 represents time, with the SFT durations marked. The vertical direction represents the amplitude of the potential difference applied to a display element. The duration 630 in FIG. 6 is the total image update time. The reset pulses 638 have two parts: the standard reset time 632, 633, 634 and the over-reset time 631 for the image transitions from black B, dark gray G1, light gray G2 and white W to dark gray G1. The over-reset time tₒᵥₑᵣ₋ᵣₑₛₑₜ 631 is constant regardless of the image transitions.

Each sequence of potential differences in FIG. 6 has only three portions: reset 638, second shaking 642 and driving 644. The first shaking pulses (440 in FIG. 4) have been removed from all transition sequences. The total image update time is shortened in this embodiment, but the image quality is diminished when compared to the first embodiment. As is the case with regard to the second embodiment discussed above, stronger image retention is expected if less shaking is used.

A fourth embodiment of the invention is schematically shown in FIG. 7, which is different from the first embodiment discussed above in that neither a first series of shaking pulses (440 in FIG. 4) nor a second series of shaking pulses (442 in FIG. 4) are present in any of the transition sequences. As in FIGS. 46, the horizontal direction in FIG. 7 represents time, with the SFT durations marked. The vertical direction represents the amplitude of the potential difference applied to a display element. The duration 730 in FIG. 7 is the total image update time. The reset pulses 738 have two parts: the standard reset time 732,733, 734 and the over-reset time 731 for the image transitions from black B, dark gray G1, light gray G2 and white W to dark gray G1. The over-reset time to tₒᵥₑᵣ₋ᵣₑₛₑₜ 731 is still constant regardless of the image transitions.

Each sequence of potential differences in FIG. 7 has only two portions: reset 738 and driving 744. As with the second and third embodiments, the delay of the grayscale introduction in this embodiment is reduced, resulting in more natural image appearance. The total image update time is further shortened. The image quality is, however, diminished when compared to any of the above the embodiments, because stronger image retention is expected if less shaking is used.

FIG. 8 illustrates a fifth embodiment according to this invention. This fifth embodiment is based on the first embodiment, using PWM driving with additional shaking pulses 849, 850, 851 in the short sequences 846, 847, 848, respectively. As in FIG.'s 4-7, the horizontal direction in FIG. 8 represents time, with the SFT durations marked. The vertical direction represents the amplitude of the potential difference applied to a display element. The duration 830 in FIG. 8 is the total image update time. The reset pulses 838 have two parts: the standard reset time 832, 833, 834 and the over-reset time 831 for the image transitions from black B, dark gray G1, light gray G2 and white W to dark gray G1. The over-reset time tₒᵥₑᵣ₋ᵣₑₛₑₜ 831 is still constant regardless of the image transitions.

Each sequence of potential differences in FIG. 8 has first shaking pulses 840, reset 838, second shaking pulses 842 and driving pulse 744. The additional shaking pulses 849, 850, 851 for the image transitions from black B, dark gray G1, light gray G2 to dark gray G1 further reduce the image retention and increase the grayscale accuracy in comparison to any of the previous embodiments, without increasing the total image update time. For optimal image quality, it is preferable to fully fill in the time space between the first shaking pulses 840 and reset pulses 838 with the additional shaking pulses 849, 850, 851. These additional shaking pulses 849, 850, 851 may differ from the first shaking pulses 840 and second shaking pulses 842 in terms of the energy involved in an additional shaking pulse 849, 850, 851. This fifth embodiment is apparently the most favorable embodiment for optimal picture quality but may consume more power.

In practice, because of image history, dwell time, inhomogeneity of the electrophoretic foils and other variables, driving of the display will rarely be ideally DC-balanced. A pixel can experience a net potential difference over a time period even if the changes in the optical state of a pixel are symmetrical during that time.

A practical example is illustrated in FIG. 9. As in FIG.'s 4-8, the horizontal direction in FIG. 9 represents time, with the SFT durations 964 marked. The vertical direction represents the amplitude of the potential difference applied to a display element. The waveform sequence at the top in FIG. 9 is an example of a DC-imbalanced W-G1-W loop. A sixth embodiment using PWM driving to achieve DC-balancing in the W-G1-W loop is shown by the waveform sequence at the bottom in FIG. 9. Each first waveform in FIG. 9 has two portions, reset 938 and driving 944, 945. The reset pulses 938 have two parts: the standard reset time 932, 933 and over-reset time 931, 941. Here, the standard reset times 932, 933 are 300 ms. The over-reset time 931 for the DC-imbalanced W-G1-W loop is 100 ms. The over-reset time 941 for the DC-balanced W-G1-W loop is 150 ms. The standard reset times 960, 961 are 200 ms and the over-reset times 962, 963 are 100 ms for the transition from dark gray G1 to white W for both the DC-unbalanced and DC-balanced W-G1-W loops.

In such practically imperfect ink material (sensitive to dwell time and image history), the dark grayscale drive pulse 944 is longer than the nominal pulse length needed for moving the particles from the black B to dark gray G1 position. The pulse length of the dark grayscale drive pulse 944 is here supposed to be 100 ms. In practice, however, in the DC-imbalanced W-G1-W loop, 140 ms is needed to achieve the correct gray level, resulting in a net DC of 40 msX(−)V=−40 ms. This may be caused by the fact that the brightness of the display is not only determined by the vertical position, but also by the exact configuration of the particles close to the position.

In order to balance this loop, one may intentionally add 50 ms of additional over-reset to the over-reset 941 in the W to G1 transition and, in the mean time, only 10 ms needs to be added in the grayscale driving portion 945 to correct the brightness change induced by the additional reset. In this way, the whole loop is completely DC-balanced. Note that the standard reset and original over-reset in G1 to W remain the same.

Thus, the present invention provides opportunities for improved DC-balancing in this situation. For example, for a display in which PWM is used to address image data to the pixels, the duration of the over-reset pulse may be varied, instead of being kept constant as is done in the first five embodiments, and that variation off-set by a smaller, additional variation in the grayscale driving time so that over time the potential difference applied to a pixel is averaged to zero. A change in the potential difference applied during the grayscale driving can compensate for, approximately, a five times larger adjustment in the potential difference applied during over-reset.

These embodiments are only some of the many possible applications of the invention in PWM driving.

The drive signal may consist of a pulse of fixed duration and varying amplitude e.g. voltage modulated (VM) driving, a pulse with a fixed amplitude, alternating polarity and a varying duration between two extreme values, and a hybrid drive signal, e.g. combined VM/PWM driving, wherein both the pulse length and the amplitude can be varied. For a pulse amplitude drive signal, this predetermined drive parameter indicates the amplitude of the drive signal including the sign thereof. For a pulse time modulated drive signal, the predetermined drive parameter indicates the duration and sign of the pulse making up the drive signal. For a hybrid generation or pulse-shaped drive signal, the predetermined drive parameter indicates the amplitude and the length of portions making up the drive pulse.

Note that this invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists. This invention is also applicable to color bi-stable displays. In a color bi-stable display, the grayscale is to be understood as that any intermediate state between two extreme colors. Also, the electrode structure is not limited. For example, a top/bottom electrode structure, honeycomb structure or other combined in-plane-switching and vertical switching may be used.

Finally, the above-discussion is intended to be merely illustrative of the present invention and should not be construed as limiting the appended claims to any particular embodiment or group of embodiments. Each of the methods and apparatuses utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference numerals in the claims are for illustration purposes only and do not limit their protective scope;
d) several “means” may be represented by the same item or hardware or software implemented structure or function; and

each of the disclosed elements may be comprised of hardware portions (e.g., discrete electronic circuitry), software portions (e.g., computer programming), or any combination thereof.

1. A display device (101) comprising:
a display element (118);
a medium capable, upon imposition of a sequence of one or more potential differences, of changing its optical state from a first optical state to one of at least four second optical states, the at least four second optical states including the first optical state;
a pixel electrode (105) and a counter electrode (106) associated the display element (118) and receiving the sequence of one or more potential differences; and
a controller (215) configured to determine and control the sequence of one or more potential differences imposed on the display element (118),
the at least four optical states comprising two extreme optical states and at least two intermediate optical states,
the particles (108, 109) being at an extreme position when the display element (118) is in one of the extreme optical states, the particles (108, 109) being at an intermediate position when the display element (118) is in one of the intermediate optical states,
the sequence of one or more potential differences comprising a reset portion for enabling a change in the optical state of the display element to one of the extreme positions, and a driving portion for enabling a change in the optical state of the display element to one of the at least four optical states,
the reset portion further comprising a standard reset portion and an over-reset potential difference,
the controller (215) being further arranged to apply the reset portion to the display element (118), the standard reset portion applied being adjusted according to a distance that the particles (108, 109) in the medium move in order to achieve one of the two extreme optical states and to apply the driving portion to the display element (118) to move the particles (108, 109) to a desired one of the intermediate optical states from one of the extreme optical states.

2. The display device (101) of claim 1, wherein the value of the over-reset potential difference applied to the display element is the same for each change in the optical state of the display element (118) to one of the at least four optical states.

3. The display device (101) of claim 2, wherein the sequence of potential differences has the same duration for each change of optical state of the display element from a first optical state to one of the at least four second optical states.

4. The display device of claim 3, wherein the distance is less than a maximum distance that particles (108, 109) in the medium can move in order to achieve one of the two extreme optical states, and the sequence of potential differences includes one or more short sequences (849, 850, 851) of additional shaking pulses of potential difference.

5. The display device (101) of claim 1, wherein the value of the over-reset potential difference applied to the display element for each change in the optical state of the display element to one of the at least four optical states is chosen without regard to the standard reset portion.

6. The display device (101) of claim 1, wherein the sequence of potential differences comprises a first set of shaking pulses and a second set of shaking pulses.

7. The display device (101) of claim 6, wherein the first set of shaking pulses is before the reset potential difference and the second set of shaking pulses is after the reset potential difference and before the driving potential difference.

8. The display device (101) of claim 1, wherein the standard reset portion is determined without reference to the other portions of the sequence of one or more potential differences.

9. The display device (101) of claim 1, wherein the over-reset potential difference and the driving portion are varied to bring the potential difference applied to the display element (118) over a time period to an average value substantially equal to zero.

10. The display device (101) of claim 9, wherein the over-reset potential difference and the driving portion are varied by offsetting a larger change in the duration over which the over-reset potential difference is applied with a smaller variation added to the potential difference applied during the driving portion.

11. The display device (101) of claim 10, wherein the smaller variation is less than or equal to 25% of the larger change.

12. A method for updating an image on a bi-stable display, the method comprising:
determining a standard reset potential difference to be applied to a display element (118) of the display taking into account a distance that particles (108, 109) of the bi-stable display must move to reach an extreme optical state of the display element (118);
applying the standard reset potential difference to a display element (118) of the bi-stable display,
applying an over-reset potential difference to the display element (118); and
applying a driving potential difference to the display element (118) corresponding to a desired optical state of the display element (118).

13. The method of claim 12, wherein: the over-reset potential difference is the same for each change of the optical state of the display element (118) to one of a plurality of desired optical states of the display element (118).

14. The method of claim 13, wherein: the standard reset duration is proportional to the distance that particles (108, 109) of the bi-stable display must move to reach an extreme optical state of the display element (118).

15. The method of claim 12, comprising applying a first series of shaking pulses (540) to the display element (118), the ending point of the first series of shaking pulses (540) being temporally adjacent to a starting point of the application of the standard reset potential difference.

16. The method of claim 12, comprising applying additional shaking pulses (849, 850, 851) in short sequences (846, 847, 848) accommodated in a duration over which the standard reset potential difference would be applied, but for the standard reset potential difference's taking into account the distance.

17. A program storage device tangibly embodying a program of instructions executable by a machine to perform a method for updating an image on a bi-stable display, the method comprising:
determining a standard reset potential difference to be applied to a display element (118) of the display taking into account a distance that particles (108, 109) of the bi-stable display must move to reach an extreme optical state of the display element (118);
applying the standard reset potential difference to a display element (118) of the bi-stable display,
applying an over-reset potential difference to the display element (118); and
applying a driving potential difference to the display element (118) corresponding to a desired optical state of the display element (118).
